(19) United States
(12) Patent Application Publication
(10) Pub. No.: US 2023/0016279 A1
(43) Pub. Date: Jan. 19, 2023

(54) ENERGY STORAGE DEVICE

(71) Applicant: Dyson Technology Limited, Wiltshire (GB)

(72) Inventor: Joseph Daniel HOWARD, Swindon (GB)

(73) Assignee: Dyson Technology Limited, Wiltshire (GB)

(21) Appl. No.: 17/783,960

(22) PCT Filed: Dec. 4, 2020
(86) PCT No.: PCT/GB2020/053121

§ 371 Date: Jun. 9, 2022

(30) Foreign Application Priority Data
Dec. 11, 2019 (GB) 1918202.1

(51) Int. Cl. H01M 10/0585; H01M 10/04; H01M 4/139

(52) U.S. Cl. CPC H01M 10/0585; H01M 10/0436; H01M 4/139; H01M 4/661

(57) ABSTRACT

A method including providing, on a substrate, first and second stacks for an energy storage device with a groove therebetween is provided. The first and second stacks each, respectively, include a first electrode layer on the substrate, an electrolyte layer on the first electrode layer, and a second electrode layer on the electrolyte layer. A first material is deposited within the groove and a second material is deposited over the first stack, the first material and the second stack to electrically connect the second electrode layers of the first and second stacks, via the second material. The first material prevents the second material from contacting the first electrode layer of the first and second stacks and the electrolyte layer of the first and second stacks, to electrically insulate the first electrode layer of the first and second stacks and the electrolyte layer of the first and second stacks from the second material.

### TECHNICAL FIELD

The present invention relates to an energy storage device and, more specifically, although not exclusively, to methods and apparatus for manufacturing an energy storage device.

### BACKGROUND

A known method of producing energy storage devices such as solid-state thin film cells comprising layers of electrodes, electrolyte and current collectors is to form a stack on a substrate. The stack comprises a first electrode layer, an electrolyte layer, and a second electrode layer. The stack is then cut into separate sections to form individual cells. Electrode layers of multiple cells stacked one on top of another are electrically connected to each other in order to connect the cells together.

Known methods for manufacturing energy storage devices can be complex and/or difficult to control. It is therefore desirable to provide a method of manufacturing an energy storage device that is more straightforward than known manufacturing methods.

### SUMMARY

According to a first aspect of the present disclosure, there is provided a method comprising:

providing, on a substrate, a first stack for an energy storage device and a second stack for the energy storage device with a groove therebetween, the first stack and the second stack each, respectively, comprising:
a first electrode layer on the substrate;
an electrolyte layer on the first electrode layer; and
a second electrode layer on the electrolyte layer;

depositing a first material within the groove; and

depositing a second material over the first stack, the first material and the second stack to electrically connect the second electrode layer of the first stack to the second electrode layer of the second stack, via the second material,

wherein the first material prevents the second material from contacting the first electrode layer of the first and second stacks and the electrolyte layer of the first and second stacks, to electrically insulate the first electrode layer of the first and second stacks and the electrolyte layer of the first and second stacks from the second material.

Depositing the second material over the first stack, the first material and the second stack can increase the contact area between the second material and the first electrode layers of the first and second stacks. This typically reduces contact resistance, and improves the performance of the manufactured energy storage device. For example, reducing contact resistance can reduce the risk of failure of the energy storage device and/or reduce unwanted heating of the energy storage device. This can, in turn, improve the safety of the energy storage device.

Using the method of the first aspect can allow manufacturing tolerances to be reduced compared with other approaches that involve the precise deposition of a very particular quantity of material. For example, compared to an alternative approach in which a small amount of conductive material is deposited in a narrow channel to form a connection to a current collector layer, the method of the first aspect need not be controlled as precisely in order to provide an adequate connection between the second material and the first electrode layers of the first and second stacks. This allows the energy storage device to be manufactured more straightforwardly and/or more efficiently than otherwise.

In examples, the groove is a first groove, and the method comprises forming a second groove through the first material and depositing the second material in the second groove. The second material deposited in the second groove can provide a greater contact area for connecting the second material to a further electrical component, such as an electrical connector for connecting a plurality of cells in parallel. For example, the electrical connector can be formed to contact a length of the second material deposited in the second groove, which typically provides a larger area of contact between the electrical connector and the second material than if the electrical connector merely contacts an edge of a layer of second material. This can further reduce contact resistance and improve the performance of the manufactured energy storage device.

In examples, depositing the second material comprises depositing the second material using a non-inkjet-printing method. This allows the second material to be deposited using a method which is more straightforward than inkjet printing, e.g. flood deposition, or a vapour deposition process such as physical vapour deposition (PVD). In PVD, the second material in a condensed phase is vaporised to produce a vapour, which vapour is then condensed onto the first stack, the first material and the second stack, whereas in flood deposition, a surface of the first stack, the first material and the second stack is flooded with liquid second material, which is subsequently hardened, e.g. by curing. Such methods may be performed without needing to control deposition of the second material according to a particular pattern or in a particular location. This allows the second material to be deposited straightforwardly and efficiently.

In examples, depositing the first material comprises depositing the first material in a non-vacuum environment and depositing the second material comprises depositing the second material in a vacuum. For example, the first material may be deposited by inkjet printing the first material in the groove in non-vacuum conditions, such as room temperature and/or pressure. The non-vacuum environment may be at least one of: an inert environment or a dry-room environment, to reduce unwanted interactions that may otherwise occur with reactive components and/or water in an ambient environment. In some cases, the first electrode layer, the electrolyte layer and the second electrode layer of the first and second stacks are deposited in a vacuum, the first material is subsequently deposited in non-vacuum conditions, before then reinstating vacuum conditions for deposition of the second material. Despite the changing of the environmental pressure during the deposition process, the electrical connections between the various components of an energy storage device manufactured according to these examples are nevertheless sufficient for effective operation of the energy storage device. Indeed, this method can increase the contact area between the second material and the first second electrode layers of the first and second stacks, which typically increases the performance of the energy storage device.

It is to be noted that the selection of which point to change environmental conditions, such as a temperature or pressure, during the manufacturing process is highly non-trivial. For example, moving from vacuum conditions to non-vacuum conditions during deposition of various layers of the first or second stacks can cause unwanted reactions to occur between these layers and the ambient environment, which may cause unwanted oxidation of at least one of these layers. Despite this, the inventors have surprisingly realised that moving from vacuum conditions to non-vacuum conditions after deposition of the second electrode layer, in order to deposit the first material, does not unduly affect the performance of the manufactured energy storage device, especially due to the increased contact area between the second electrode layer and the subsequently deposited second material.

In examples, the method comprises depositing a first layer of the second material over the first stack and the second stack before depositing the first material within the groove, and subsequently depositing the second material over the first stack, the first material and the second stack, as a second layer of the second material. The first layer of the second material for example protects the underlying second electrode layer during the deposition of the first material, reducing the risk of potential contamination of or unwanted reactions with the second electrode layer. This may improve the electrical connection between the second electrode layer and the second material (via the first layer of the second material), improving the functionality of the manufactured energy storage device. In these examples, depositing the first layer of the second material may comprise depositing the first layer of the second material in a vacuum and depositing the first material may comprise depositing the first material in a non-vacuum environment. Changing the environmental conditions from vacuum conditions to non-vacuum conditions may lead to degradation of surfaces of the first and/or second stacks that are exposed to the non-vacuum conditions. However, the first layer of the second material may be less sensitive to exposure to the non-vacuum environment (during deposition of the first material) than the underlying second electrode layer. For example, whereas the second electrode layer may comprise lithium, which is highly reactive and hence likely to react with molecules in a non-vacuum environment, the second material may comprise copper, which is less reactive. In other cases, the second material may comprise another electrically conductive material that is less reactive than the second electrode layer. In this way, an electrical connection between the first and second layers of the second material may be improved (e.g. with reduced degradation and/or contact resistance) compared to an electrical connection between a second electrode layer and the second material in cases in which the second electrode layer has been exposed to non-vacuum conditions.

In examples, the first stack is on a first portion of the substrate, the second stack is on a second portion of the substrate and depositing the second material comprises depositing a portion of the second material on a third portion of the substrate, between the first and second portions of the substrate. The portion of the second material on the third portion of the substrate for example provides a larger surface area of the second material for subsequent connection to a further electrical component, such as an electrical connector. This can reduce contact resistance and therefore improve the performance of the manufactured energy storage device.

In examples, the first stack and the second stack each, respectively, comprise a first surface on the substrate and a second surface opposite to the first surface. In such examples, depositing the second material over the first stack, the first material and the second stack may comprise depositing the second material to cover substantially all of the second surface of at least one of the first or second stacks. This provides a larger contact area between the second material and the second electrode layers of the first and second stacks, which further reduces contact resistance and improves the performance of the manufactured energy storage device.

In examples, the method comprises depositing a combined stack comprising the first stack and the second stack, and forming the groove through the combined stack to form the first stack and the second stack with the groove therebetween. This simplifies formation of the groove compared to forming a forming a groove through the first electrode layer, then depositing the electrolyte layer and extending the groove through the electrolyte layer and then subsequently depositing the second electrode layer and extending the groove through the second electrode layer. In these examples, a width of the groove may be substantially constant through the combined stack. This further simplifies formation of the groove compared to other cases in which the groove has a stepped profile, with a varying width through the combined stack (e.g. so that the width of a portion of the groove through the first electrode layer is less than a width of a portion of the groove through the electrolyte layer, which is in turn less than a width of a portion of the groove through the second electrode layer).

In examples, the second electrode layer comprises lithium. The second material may comprise copper. These materials are suitable for the formation of an effective energy storage device.

In examples, the method comprises, after depositing the second material, separating a first portion of the substrate on which the first stack is arranged from a second portion of the substrate on which the second stack is arranged, the separating comprising cutting through the second material within the groove. In this way, a first and second cell (comprising the first and second stacks, respectively) can be singulated from each other, allowing the first and second cells to be stacked one on top of the other and connected together and/or to a further electrical component such as an electrical connector. By depositing the second material before cell singulation, the method is more efficient than otherwise, as the second material can be deposited for a plurality of cells in a single processing step, rather than individually depositing the second material on a stack of each individual cell.

In examples, the method comprises, after depositing the second material, forming a further groove through the first stack to expose the first electrode layer of the first stack within the further groove. The exposed first electrode layer can be connected to another electrical component, such as an exposed first electrode layer of another stack, to connect cells in parallel. By exposing the first electrode layer after deposition of the second material, the first electrode layer remains protected by the electrolyte and second electrode layers during the previous processing steps. This can reduce unwanted reactions of the first electrode layer with other components, which may otherwise occur if the first electrode layer is exposed earlier in the processing method. This can in turn improve the performance of the manufactured energy storage device by reducing degradation of the first electrode layer. In some of these examples, the method comprises forming the further groove through the first stack and through the substrate. With this approach, the first electrode layer can be exposed during singulation of a cell comprising the first stack from a neighbouring cell. This improves the efficiency of the method compared to exposing the first electrode layer and performing cell singulation separately.

According to a second aspect of the present disclosure, there is provided an energy storage device formed by the method according to the first aspect of the present disclosure. Such an energy storage device may have improved performance due to a reduction in contact resistance between the second electrode layer and the second material, as explained with reference to the first aspect. In addition or alternatively, such an energy storage device may be manufactured efficiently and in a straightforward manner.

According to a third aspect of the present disclosure, there is provided an intermediate structure for an energy storage device, the intermediate structure comprising:

a substrate;

a first stack for the energy storage device on the substrate;

a second stack for the energy storage device on the substrate,

the first stack and the second stack each, respectively, comprising:
a first electrode layer on the substrate;
an electrolyte layer on the first electrode layer; and
a second electrode layer on the electrolyte layer;

a first material between the first stack and the second stack; and

a second material over the first stack, the first material and the second stack to electrically connect the second electrode layer of the first stack to the second electrode layer of the second stack, via the second material,

wherein the first material prevents the second material from contacting the first electrode layer of the first and second stacks and the electrolyte layer of the first and second stacks, to electrically insulate the first electrode layer of the first and second stacks and the electrolyte layer of the first and second stacks from the second material.

The third aspect relates to an intermediate structure for an energy storage device which may be manufactured more straightforwardly or more efficiently. For example, the intermediate structure may be manufactured using methods in accordance with the first aspect of the invention. An energy storage device manufactured using the intermediate structure of the third aspect may exhibit improved performance compared to an energy storage device manufactured in a different manner.

In examples, the first stack is on a first portion of the substrate, the second stack is on a second portion of the substrate and a portion of the second material is on a third portion of the substrate, between the first portion of the substrate and the second portion of the substrate. The portion of the second material on the third portion of the substrate provides a larger surface area for connection of the second material to a further electrical component, which can reduce contact resistance and improve performance of the manufactured energy storage device.

In examples, the first stack and the second stack each, respectively, comprise a first surface on the substrate and a second surface opposite to the first surface, and the second material overlaps substantially all of the second surface of at least one of the first or second stacks. The contact area between the second material and the second electrode layers of the first and second stacks in these examples is greater than if the second material overlaps less of the second surface of the first and/or second stacks.

This reduces contact resistance and improves the performance of the energy storage device manufactured using the intermediate structure.

Further features will become apparent from the following description, given by way of example only, which is made with reference to the accompanying drawings.

### BRIEF DESCRIPTION OF THE DRAWINGS

FIG. 1 is a schematic diagram that shows a stack for an energy storage device according to examples;

FIGS. 2a to 2g are schematic diagrams that show features of a method of manufacturing an energy storage device according to examples;

FIG. 3 is a schematic diagram that shows an intermediate structure for manufacturing an energy storage device according to further examples; and

FIGS. 4a to 4e are schematic diagrams that show features of a method of manufacturing an energy storage device according to further examples.

### DETAILED DESCRIPTION

Details of methods, structures and devices according to examples will become apparent from the following description, with reference to the Figures. In this description, for the purpose of explanation, numerous specific details of certain examples are set forth. Reference in the specification to “an example” or similar language means that a particular feature, structure, or characteristic described in connection with the example is included in at least that one example, but not necessarily in other examples. It should further be noted that certain examples are described schematically with certain features omitted and/or necessarily simplified for ease of explanation and understanding of the concepts underlying the examples.

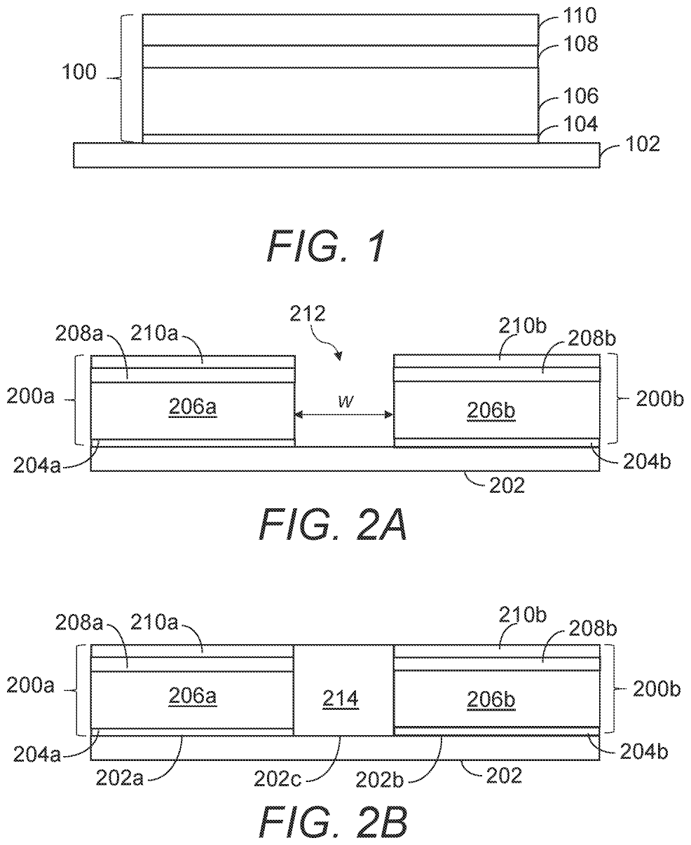

FIG. 1 shows a stack 100 of layers for an energy storage device. The stack 100 of FIG. 1 may be used as part of a thin film energy storage device having a solid electrolyte, for example.

The stack 100 comprises a substrate 102, a cathode current collector (CC) layer 104, a cathode layer 106, an electrolyte layer 108, and an anode layer 110. In the example of FIG. 1, the anode layer 110 is further from the substrate 102 than the cathode layer 106, and the electrolyte layer 108 is between the cathode layer 106 and the anode layer 110. The substrate 102 contacts the cathode CC layer 104 and supports the stack 100. While in this example the substrate 102 directly contacts the cathode CC layer 104, in other examples there may be additional layers (not shown) in between the substrate 102 and the cathode CC layer 104, or the cathode CC layer may be omitted and the cathode layer 106 may be in contact with the substrate 102. Unless otherwise indicated, reference herein to an element being “on” another element is to be understood as including direct or indirect contact. In other words, an element on another element may be either touching the other element, or not in contact the other element but, instead, generally supported by an intervening element (or elements) but nevertheless located above, or overlapping, the other element.

The substrate 102 of FIG. 1 is a polymer, such as polyethylene terephthalate (PET). In other examples, the substrate 102 may be or comprise a different material, such as silicon or a glass. The substrate 102 in FIG. 1 is planar and flexible (in this case, sufficiently flexible that the substrate 102 can be wound around a roller as part of a roll-to-roll manufacturing process, sometimes referred to as a reel-to-reel process). In other examples, though, the substrate may be non-planar and/or rigid.

The cathode CC layer 104 acts as a positive current collecting layer and in this case comprises nickel foil, but it will be appreciated that any suitable metal could instead be used, such as aluminium, copper or steel, or a metallised material including metallised plastics such as aluminium on polyethylene terephthalate (PET).

The cathode layer 106 of FIG. 1 forms a positive electrode layer (i.e. that corresponds to a cathode during discharge of a cell of an energy storage device including the stack 100). The cathode layer 106 in the example of FIG. 1 comprises a material which is suitable for storing lithium ions by virtue of stable chemical reactions, such as lithium cobalt oxide, lithium iron phosphate or alkali metal polysulphide salts.

The anode layer 110 of FIG. 1 forms a negative electrode layer (i.e. that corresponds to an anode during discharge of a cell of the energy storage device including the stack 100). The anode layer 110 in this case comprises lithium. However, in other examples, the anode layer may comprise lithium, graphite, silicon and/or indium tin oxide.

The electrolyte layer 108 may include any suitable material which is ionically conductive, but which is also an electrical insulator such as lithium phosphorous oxynitride (LiPON). The electrolyte layer 108 of FIG. 1 is a solid layer, and may be referred to as a fast ion conductor. A solid electrolyte layer may have structure which is intermediate between that of a liquid electrolyte, which for example lacks a regular structure and includes ions which may move freely, and that of a crystalline solid. A crystalline material for example has a regular structure, with an ordered arrangement of atoms, which may be arranged as a two-dimensional or three-dimensional lattice. Ions of a crystalline material are typically immobile and may therefore be unable to move freely throughout the material.

The stack 100 of FIG. 1 is manufactured by depositing the cathode CC layer 104 on the substrate 102. The cathode layer 106 is subsequently deposited on the cathode CC layer 104, the electrolyte layer 108 is then deposited on the cathode layer 106, and the anode layer 110 is then deposited on the electrolyte layer 108. Each layer of the stack 100 may be deposited by flood deposition (sometimes referred to as slot die coating or slit coating), which provides a simple and effective way of producing a highly homogenous layer, although other deposition methods are possible, e.g. a vapour deposition process such as physical vapour deposition (PVD) or chemical vapour deposition (CVD).

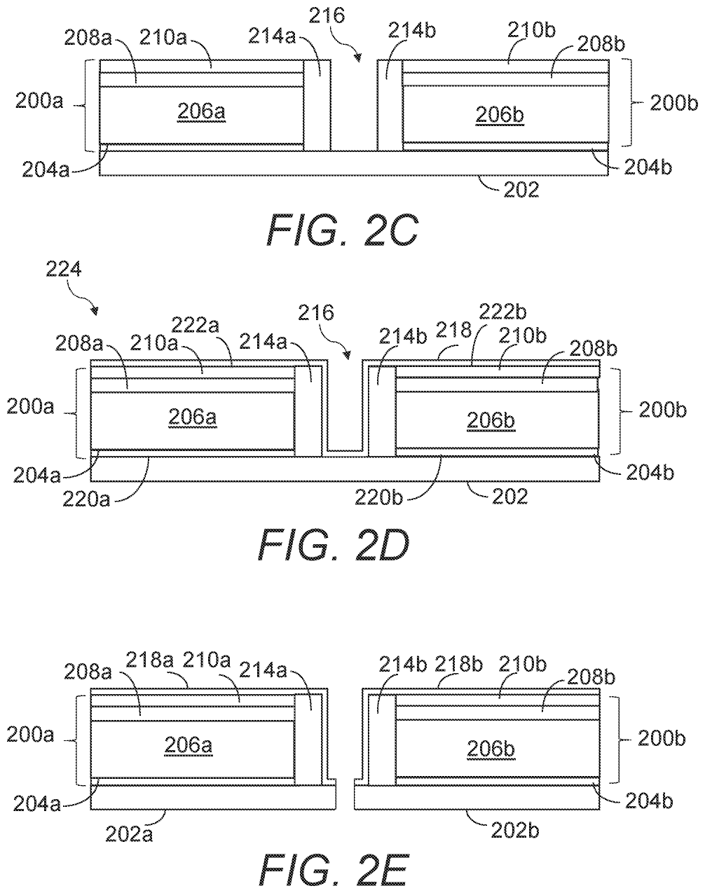

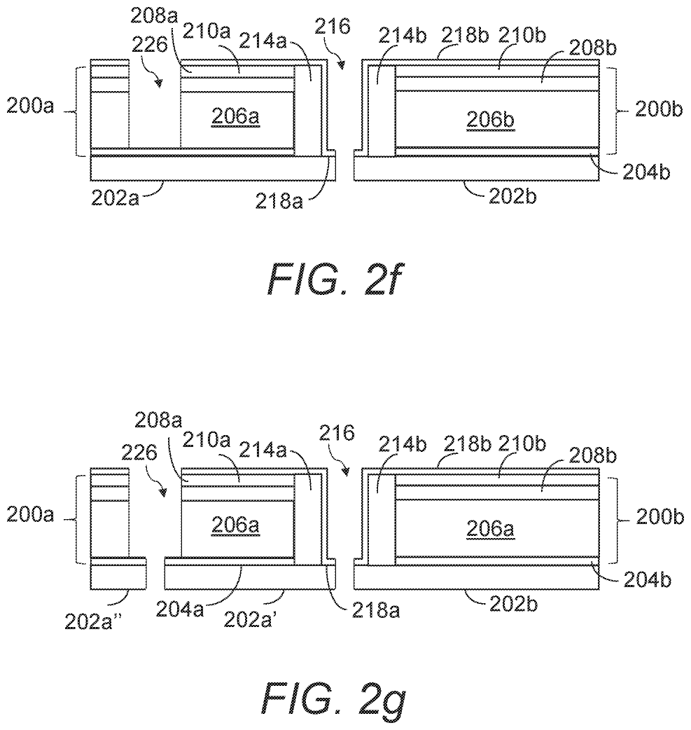

In examples herein, stacks similar to or the same as the stack 100 of FIG. 1 undergo processing to manufacture an energy storage device. FIGS. 2a to 2g are schematic diagrams that show features of a method of manufacturing an energy storage device according to examples. Features of FIGS. 2a to 2g that are similar to corresponding features of FIG. 1 are labelled with the same reference numeral but incremented by 100. Corresponding descriptions are to be taken to apply.

Prior to FIG. 2a, a plurality of layers has been deposited on a substrate 200. The plurality of layers in this case includes the same layers as the layers in the stack 100 of FIG. 1, and may have been manufactured in the same way.

FIG. 2a illustrates the formation of a groove 212 through the plurality of layers so as to provide a first stack 200a on the substrate 202 and a second stack 200b on the substrate 202. A groove is for example a channel, slot or trench that may be continuous or non-continuous. In some examples, such as that of FIG. 2a, a groove is elongate. In FIG. 2a, the groove is elongate in a direction into and out of the page (as shown in FIG. 2a), forming an elongate trench across the plurality of layers.

The plurality of layers through which the groove 212 is formed may be considered to be a combined stack comprising the first and second stacks 200a, 200b. The first stack 200a comprises a first electrode layer 206a on the substrate 202, an electrolyte layer 208a on the first electrode layer 206a and a second electrode layer 210a on the electrolyte layer 208a. The second stack 200b similarly comprises a first electrode layer 206b on the substrate 202, an electrolyte layer 208b on the first electrode layer 206b and a second electrode layer 210b on the electrolyte layer 208b. The first electrode layers 206a, 206b in this case are cathode layers, like the cathode layer 106 of FIG. 1, and comprise a material which is suitable for storing lithium ions. The second electrode layers 210a, 210b are anode layers, like the anode layer 110 of FIG. 1, and comprise lithium. However, this is merely an example. The first and second stacks 200a, 200b in the example of FIG. 2a additionally include current collector (CC) layers 204a, 204b, which are cathode CC layers like the cathode CC layer 104 of FIG. 1. However, the CC layers 204a, 204b may be omitted from the method described with reference to FIGS. 2a and 2g. In such cases, the substrate 202 may be metallised or comprise an electrically conductive surface layer, or the first electrode layers 206a, 206b may perform the functionality of both an electrode and a current collector.

The plurality of layers of FIG. 2a may be deposited under vacuum conditions. It is to be appreciated that a vacuum as referred to herein is not necessarily a perfect vacuum, but instead refers to an environment in which the pressure is sufficiently lower than atmospheric pressure to reduce unwanted interactions between the deposited layers and environmental molecules. Deposition of the layers of FIG. 2a under vacuum conditions may limit or avoid interactions of the layers with the environment, which can degrade the layers. For example, as discussed above, the second electrode layers 210a, 210b of FIG. 2a include lithium, which is highly reactive. Hence, by depositing the second electrode layers 210a, 210b in a vacuum, unwanted reactions between the second electrode layers 210a, 210b and molecules within a surrounding environment are reduced.

The example of FIG. 2a includes laser ablation of the layers to form the groove 212 in FIG. 2a so as to provide the first and second stacks 200a, 200b. Laser ablation involves irradiating the layers with a laser beam, causing portions of the layers to evaporate, sublimate or be converted to a plasma and therefore be removed. The amount of the layers removed by the laser ablation may be controlled by controlling properties of the laser beam such as the wavelength of the laser beam or a pulse length of a pulsed laser beam. Laser ablation typically allows the formation of the groove 212 to be controlled in a straightforward and rapid manner. However, in other examples, alternative methods may be used to form the groove 212, such as photolithographic techniques.

In FIG. 2a, a width w of the groove 212 is substantially constant through the combined stack (which in this case is laser ablated to separate the combined stack into the first and second stacks 200a, 200b). A width may be considered substantially constant where it is constant or constant within manufacturing tolerances or measurement uncertainties. The width w of the groove 212 is taken in a direction parallel to a plane of the substrate 202 in the example of FIG. 2a. Due to the substantially constant width w of the groove 212, the cross-section of the groove 212 in a plane perpendicular to the plane of the substrate 202 is rectangular in shape. Formation of the groove 212 with such a shape is typically more straightforward than forming a groove 212 with a more complex shape, such as a stepped shape in cross-section. Compared to formation of a groove with a more complex shape, the laser ablation need not be controlled as precisely to form the groove 212 with a substantially constant width w. This allows the energy storage device to be formed more easily and/or more efficiently. However, it is to be appreciated that this is merely an example groove shape. In other cases, the groove 212 may have a different shape in cross-section, such as a stepped shape or a V-shape in cross-section.

In FIG. 2b, a first material 214 is deposited in the groove 212. The first material 214 is electrically insulating. An electrically insulating material may be considered to be electrically non-conductive and may therefore conduct a relatively a small amount of electric current when subjected to an electric field. Typically, an electrically insulating material (sometimes referred to as an insulator) conducts less electric current than semiconducting materials or electrically conductive materials. However, a small amount of electric current may nevertheless flow through an electrically insulating material under the influence of an electric field, as even an insulator may include a small amount of charge carriers for carrying electric current. In examples herein, a material may be considered to be electrically insulating where it is sufficiently electrically insulating to perform the function of an insulator. This function may be performed for example where the material insulates one element from another sufficiently for short circuits to be avoided.

The first material 214 in the example of FIG. 2b is deposited using inkjet printing, which allows the electrically insulating material 130a to be deposited accurately and precisely. For example, depositing the first material 214 by inkjet printing, typically allows flexible, efficient, and/or reliable deposition of the first material 214. For example, inkjet printing may be performed at relatively low (e.g. ambient) temperatures and/or pressures, for example as compared to thermal spray coating, and hence may allow for economic and/or efficient deposition and hence cell production. Inkjet printing of the first material 214 in the example of FIG. 2b involves inkjet printing the first material 214 in the form of liquid ink, and curing the deposited ink to form a solid layer of the first material 214. A suitable ink for use as the first material 214 is DM-INI-7003, available from Dycotec Materials Ltd., Unit 12 Star West, Westmead Industrial Estate, Westlea, Swindon, SN5 7SW, United Kingdom. This ink is a dielectric ink, which is for example an electrical insulator which may be polarized upon application of an electric field. A dielectric material typically also has a low electrical conductivity to insulate the edges of the first and second stacks 200a, 200b within the groove 212. In other cases, though, a different deposition method than inkjet printing may be used to deposit the first material. In such cases, the first material may be or comprise a different material than a dielectric ink.

The first material 214 is deposited in a non-vacuum environment in the example of FIG. 2b. A non-vacuum environment is generally considered to be an environment that is not held under vacuum, which e.g. has a pressure greater than the pressure within a vacuum environment. For example, the non-vacuum environment may be at atmospheric pressure. Use of a non-vacuum environment for deposition of the first material 214 simplifies the deposition process, by relaxing environmental constraints. Despite the non-vacuum environment, the first material 214 (and/or exposed surfaces of the first and second stacks 200a, 200b) may not be adversely affected by interactions with molecules in a surrounding environment. This allows the first material 214 to be deposited straightforwardly, without unduly affecting the performance of the manufactured energy storage device.

In FIG. 2, the non-vacuum environment is an inert environment and therefore includes at least one inert gas such as argon. An inert environment is generally considered to be unreactive and typically lacks reactive materials or includes a sufficiently low concentration of reactive materials (e.g. compared to inert materials) that reactions between the environment and the first and second stacks 200a, 200b and/or first material 214 are sufficiently low that the performance of the manufactured energy storage device is unaffected or not significantly affected by any such reactions. This further improves the quality of the manufactured energy storage device.

The non-vacuum environment may be a dry-room environment in addition to or instead of being an inert environment. A dry-room environment typically refers to an environment with a relatively low humidity compared to atmospheric humidity. As an example, a dry-room environment may have a temperature from 20 degrees Celsius to degrees Celsius and a humidity of less than 1%. This can further reduce unwanted interactions between the first stack 200a, the second stack 200b and/or the first material 214 with the surrounding environment.

In FIG. 2b, the first stack 200a is arranged on a first portion 202a of the substrate 202 and the second stack 200b is arranged on a second portion 202b of the substrate 202. A third portion 202c of the substrate 202 is between the first and second portions 202a, 20b. The first material 214 is deposited on the third portion 202c of the substrate 202 to form a plug which fills the groove 212 formed previously. The first material 214 covers exposed edges of the CC layers 204a, 204b, the first electrode layers 206a, 206b. the electrolyte layers 208a, 208b and the second electrode layers 210a, 210b of the first and second stacks 200a, 200b. In this way, the first electrode layers 206a, 206b and the second electrode layers 210a, 210b of each of the stacks 200a, 200b are electrically insulated from each other. In other examples, though, the first material 214 need not entirely fill the groove 212 but nevertheless electrically insulates the first electrode layers 206a, 206b and the second electrode layers 210a, 210b of each of the stacks 200a, 200b from each other.

In FIG. 2c, a groove 216 is formed through the first material 214. This separates the first material 214 into a first portion 214a arranged to cover an exposed edge of the first stack 200a and a second portion 214b arranged to cover an exposed edge of the second stack 200b. The groove 212 formed in FIG. 2a, which is through the combined stack, may be referred to as a first groove 212, and the groove 216 formed in FIG. 2c may be referred to as a second groove 216, for ease of reference. The second groove 216 has a smaller width than the first groove 212, so that the first and second portions 214a, 214b of the first material remain between the first and second stacks 200a, 200b, to electrically insulate the exposed edges of the first and second stacks 200a, 200b. The second groove 216 is formed in the same way as the first groove 212 in the example of FIG. 2c (i.e. using laser ablation). However, in other examples, the second groove 216 may be formed using a different process, which itself may be the same as or different from a process used to form the first groove 212.

In the example of FIG. 2c, the second groove 216 extends through the depth of the first material 214 to expose a portion of the substrate 202 that was previously covered by the first material 214. The second groove 216 in this case therefore forms a through-hole through the first material 214. However, this need not be the case in other examples, such as those in which the second groove has a smaller depth so as to extend only partway through the depth of the first material 214, or in which formation of the second groove is omitted.

In FIG. 2d, a second material 218 is deposited over the first stack 200a, the first material 214 and the second stack 200b. The second material 218 in this example is electrically conductive. Electrical current can therefore flow through the second material 218 due to the flow of ions or electrons through the second material 218. The second material 218 electrically connects the second electrode layer 210a of the first stack 200a to the second electrode layer 210b of the second stack 200b, via the second material 218. The first and second stacks 200a, 200b can be electrically connected to a further electrical component via the second material 218.

The second material 218 acts as a negative CC layer (sometimes referred to as an anode CC layer) in the example of FIG. 2d. The second material 218 contacts the second electrode layer 210a, 210b of the first and second stacks 200a, 200b, which in this case correspond to anodes during discharge of cells formed from the first and second stacks 200a, 200b respectively. The second material 218 in this example comprises copper. However, it will be appreciated that any suitable metal could be used, such as aluminium, nickel foil or steel, or a metallised material including metallised plastics such as aluminium on polyethylene terephthalate (PET).

The deposition of the second material 218 over the first and second stacks 200a, 200b increases a contact area between the second material 218 and the second electrode layers 210a, 210b compared to other cases in which an anode or anode CC is connected to a further electrical component, such as an electrical connector, along an exposed side edge of the anode or anode CC. For example, a side edge of such an anode or anode CC for connection to an electrical connector typically has a much smaller area than an area of a surface of the first and second stacks 200a, 200b on which the second material 218 is deposited in FIG. 2d. In examples such as FIG. 2e, an area of contact between the second material 218 and the second electrode layer 210a, 210b of at least one of the first or second stacks 200a, 200b is larger than an area of an edge surface of the second electrode layer 210a, 210b within the second groove 216. Increasing the contact area typically reduces the contact resistance at the interface between the second material 218 and the second electrode layers 210a, 210b, which improves the performance of the manufactured energy storage device.

The second material 218 in examples such as FIG. 2d is deposited using a non-inkjet-printing method, which is a deposition method that does not involve inkjet printing techniques. Such methods may be more straightforward and economic than inkjet printing. Suitable methods include vapour deposition methods such as PVD or CVD, or flood deposition. With these methods, the second material 218 can be deposited over the surface of the structure shown in FIG. 2c, to form a layer of the second material 218 over the surface of this structure as shown in FIG. 2d. This allows the second material 218 to be deposited over the exposed surface of the structure without having to precisely control where the second material 218 is deposited. This can simplify deposition of the second material 218 compared to deposition of the second material 218 according to a particular pattern (e.g. in which second material is deposited on some areas of a surface, but not others). Furthermore, at least some non-inkjet-printing methods are more economic and/or more straightforward than inkjet printing techniques.

In FIG. 2d, the first and second stacks 200a, 200b each comprise a first surface 220a, 220b on the substrate 202 and a second surface 222a, 222b opposite to the first surface 220a, 220b. The second material 218 is deposited to cover substantially all (in this case, all) of the second surface 222a, 222b of both of the first and second stacks 200a, 200b. This further simplifies deposition of the second material 218 and further increases a contact area between the second material 218 and the second electrode layers 210a, 210b. Deposition of the second material 218 in this way for example involves encapsulating the second surfaces 222a, 222b, of the first and second stacks 200a, 200b using the second material 218. This protects the second surfaces 222a, 222b by reducing contact between the second surfaces 222a, 222b and a surrounding environment, e.g. due to the arrangement of the second material 218 as a barrier between the second surfaces 222a, 222b and the environment. The second material 218 therefore protects the second surfaces 222a, 222b from potential damage or interaction with an ambient environment.

It is to be appreciated that deposition of the second material 218 to cover substantially all of a given surface for example refers to the second material 218 being deposited to cover all of the given surface, all of the given surface within manufacturing tolerances or measurement tolerances or a substantial part of the given surface, such as more than 80% of the given surface. In this way, after deposition, the second material 218 overlaps substantially all of the second surfaces 222a, 22b of the first and second stacks 200a, 200b in FIG. 2d. The second material 218 is deposited on, and in contact with, the second surfaces 222a, 222b of the first and second stacks 200a, 200b in the example of FIG. 2d. However, in other examples, the second material 218 may be deposited such that there is at least one intervening layer between the second material 218 and the second surfaces 222a, 222b of the first and second stacks 200a, 200b but such that the second material 218 nevertheless overlaps the second surfaces 222a, 222b. In such cases, the at least one intervening layer is generally electrically conductive, such that the second material 218 is electrically connected to the second electrode layers 210a, 210b, via the at least one intervening layer.

In FIG. 2d, the second material 218 is deposited in the second groove 216 formed through the first material 214. In this case, as the second groove 216 extends through the first material 214 to exposed part of the third portion 202c of the substrate 202, the second material 218 is also deposited on this part of a third portion 202c of the substrate 202. However, in other examples, the second material 218 may contact a different part of the substrate 202 or may not contact the substrate 202 (e.g. if the second groove 216 extends only partway through the first material 214 such that the substrate 202 is not exposed by the formation of the second groove 216, or if formation of the second grove is omitted). The third portion 202c of the substrate 202 is between first and second portions 202a, 202b of the substrate 202 on which the first and second stacks 200a, 200b are arranged. The first, second and third portions 202a, 202b, 202c are labelled in FIG. 2b, but omitted from FIG. 2d, for clarity. By depositing the second material 218 over the first stack 200a, the first material 214, part of the third portion 202c of the substrate 202 and the second stack 200b, the second material 218 may be deposited as a layer, e.g. a continuous layer, covering the structure of FIG. 2c. Again, this may simplify deposition of the second material 218 compared to depositing the second material on some area of the structure and not on others.

By depositing the second material 218 within the second groove 216, an area of the second material 218 for subsequent connection to a further electrical component, such as an electrical connector, is increased compared to other cases in which the second material 218 does not extend into the second groove 216. For example, an electrical connector may subsequently be deposited along a length of the second material 218 which is within the second groove 216 (which length is taken perpendicular to the width w of the first groove 212 illustrated in FIG. 2a). The length of the second material 218 within the second groove 216 in examples is greater than a width of the layer of second material 218. Hence, by providing the electrical connector in contact with the length of the second material 218, a contact area may be increased compared to other cases in which the electrical connector contacts a side edge of an anode, anode CC, or electrically conductive material connected to the anode or anode CC (which typically has a much smaller surface area than a surface area of the length of the second material 218).

In the example of FIG. 2d, the second material 218 is deposited in a vacuum. Hence, in this case, the first and second stacks 200a, 200b are formed in a vacuum, the first material 214 is deposited in a non-vacuum environment, and the second material 218 is deposited in a vacuum. Nevertheless, despite the change in environmental conditions, the increase in contact area between the second material 218 and the second electrode layer 210a, 210b has been found to provide an overall improvement in performance of the manufactured energy storage device.

After deposition of the second material 218, the first material 214 prevents the second material 218 from contacting the first electrode layer 206a, 206b of the first and second stacks 200a, 200b and the electrolyte layer 208a, 208b of the first and second stacks 200a, 200b, to electrically insulate the first electrode layer 210a, 210b of the first and second stacks 200a, 200b and the electrolyte layer 208a, 208b of the first and second stacks 200a, 200b from the second material 218. The first material 214 therefore acts as an insulating layer, to prevent or reduce the risk of a short circuit between the first and second electrode layers 206a, 210a of the first stack 200a, and between the first and second electrode layers 206b, 210b of the second stack 200b.

The structure of FIG. 2d may be considered to be an intermediate structure 224 for an energy storage device. The energy storage device may be manufactured from the intermediate structure 224 by further processing of the intermediate structure 224. An example of further processing that may be applied to the intermediate structure 224 is shown in FIG. 2e, in which a first portion 202a of the substrate 202 on which the first stack 200a is arranged is separated from a second portion 202b of the substrate 202 on which the second stack 200b is arranged. Any suitable cutting method may be used to perform the separation, such as laser cutting. In FIG. 2e, separation of the first and second portions 202a, 202b of the substrate 202 includes cutting through the second material 218 within the groove between the first and second stacks 200a, 200b. The second material 218 is thereby separated into a first portion 218a that covers the first stack 200a and the first portion 214a of the first material 214, and a second portion 218b that covers the second stack 200b and the second portion 214b of the first material 214. In this way, the first and second stacks 200a, 200b are separated from each other, which may be referred to as singulation or cell singulation.

In FIG. 2f, a further groove 226 is formed through the first stack 200a to expose the first electrode layer 206a within the further groove 226. In this example, the further groove 226 extends entirely through the first portion 218a of the second material 218, the second electrode layer 210a, the electrolyte layer 208a and the first electrode layer 206a, without extending into the CC layer 204a. This exposes edges of the first portion 218a of the second material 218, the second electrode layer 210a, the electrolyte layer 208a and the first electrode layer 206a, and an upper surface of the CC layer 204a (opposite to a surface of the CC layer 204a on the substrate 200). This allows subsequent connection of the first electrode layer 206a and/or the CC layer 204a to a further electrical component, such as an electrical connector to connect cells in series or parallel. By exposing the first electrode layer 206a after the deposition of the second material 218, the first electrode layer 206a remains protected by the other layers of the stack 200a throughout the previous processing. This reduces the risk of unwanted interactions between the first electrode layer 206a.

FIG. 2g illustrates that, in some examples (such as that shown), forming the further groove 226 through the first stack 200a includes forming the further groove 226 through the first stack 200a and through the substrate 202. In other words, FIG. 2f illustrates a snapshot partway through the formation of the further groove 226, at which point the further groove 226 extends partway through the first stack 200a. The formation of the further groove 226 has been continued to obtain the structure shown in FIG. 2g. In FIG. 2g, the further groove 226 has been formed through an entirety of the first stack 200a and the first portion 202a of the substrate 202 on which the first stack 200a is arranged, to separate the substrate 202 into first and second sub-portions 202a′, 202a″. This therefore singulates the portion of the first stack 200a on the first sub-portion 202a′ of the substrate 202 from the remaining portion of the layers, forming a first cell for an energy storage device. By forming the further groove 226 to both expose the first electrode layer 206a and the CC layer 204a and to singulate the first cell, the energy storage device can be manufactured more efficiently than if these processes are performed separately.

In some cases, the processes of FIGS. 2e and 2g may be performed at the same time or as part of the same process step (e.g. using the same equipment). For example, a laser cutter may be directed across a surface of the intermediate structure 224 to cut the substrate 202 to separate the first and second portions 202a, 202b from each other, and to separate the first and second sub-portions 202a′, 202a″ from each other (as well as to expose the first electrode layer 206a and the CC layer 204a of the first stack 200a). This further improves the efficiency of manufacturing the energy storage device.

After singulation of respective cells, e.g. as shown in FIGS. 2e to 2g, the exposed first electrode layers may be suitably insulated and the singulated cells may be stacked one on top of the other. Electrical connectors may then be provided along opposite sides of a cell, such that a first electrical connector on one side of the cell contacts the CC layer 204 but is prevented from contacting the other layers by electrically insulating material. Similarly, a second electrical connector on an opposite side of the cell can be arranged in contact with the second material 218, but is prevented from contacting the other layers by the first material 214. As discussed above, the second electrical connector may be deposited to cover the second material 218 along the side of the first stack 200a shown in FIG. 2g (i.e. in a plane perpendicular to a plane of the substrate 202). For example, the second electrical connector may contact all, substantially all or a majority of the portion of the second material 218 arranged along the side of the first stack 200a. This increases the contact area between the second electrical connector and the second material 218, further reducing contact resistance. The first and second electrical connectors may, for example, be a metallic material that is applied to the edges of a cell stack by sputtering. The cells of a cell stack can therefore be joined in parallel simply and easily.

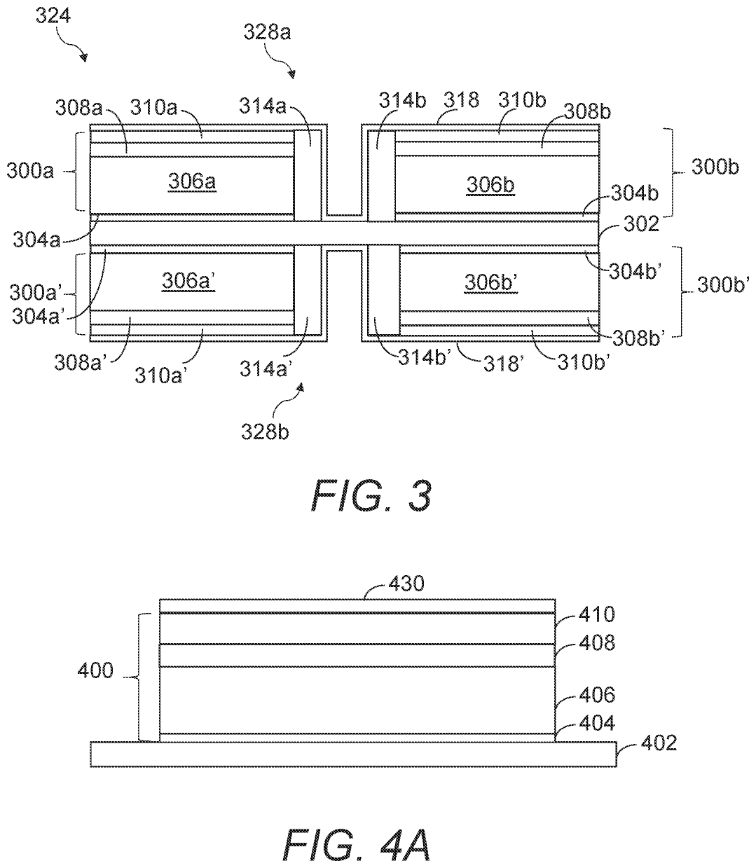

In some cases, double-sided processing may be performed, in which a plurality of layers is deposited on opposite sides of the same substrate, i.e. so that both sides of the substrate include a plurality of layers thereon. An example of an intermediate structure 324 formed by double-sided processing is shown schematically in FIG. 3. Features of the intermediate structure 324 of FIG. 3 that are similar to the intermediate structure 224 of FIG. 2b are labelled with the same reference numeral but incremented by 100. Corresponding descriptions are to be taken to apply.

The layers arranged on a first side 328a of the substrate 302 of the intermediate structure 324 of FIG. 3 are the same as the layers arranged on the substrate 202 of the intermediate structure 224 of FIG. 2d, and include a first stack 300a, a second stack 300b, first material 314 and second material 318 covering the first and second stacks 300a, 300b and the first material 314. In this example, these layers are deposited in the same manner as the deposition of the layers of the intermediate structure 224 as described with reference to FIGS. 2a to 2d.

A second side 328b of the substrate 302 of the intermediate structure 324 of FIG. 3 also includes the same layers thereon as those arranged on the first side 328a, in the same order. The layers on the second side 328b of the substrate 302 are also deposited in the same manner as the deposition of the layers of the intermediate structure 224 as described with reference to FIGS. 2a to 2d but on the opposite side of the substrate 302 to the layers on the first side 328a of the substrate 302. Each layer on the second side 328b of the intermediate structure 324 is the same as a corresponding layer on the first side 328a of the intermediate structure 324 and is labelled with the same reference numeral but appended with a prime.

By depositing layers on either side of the substrate 302, the efficiency of the manufacturing process may be further improved. For example, the number of laser cutting processes may be reduced, as each cut may pass through a greater number of layers.

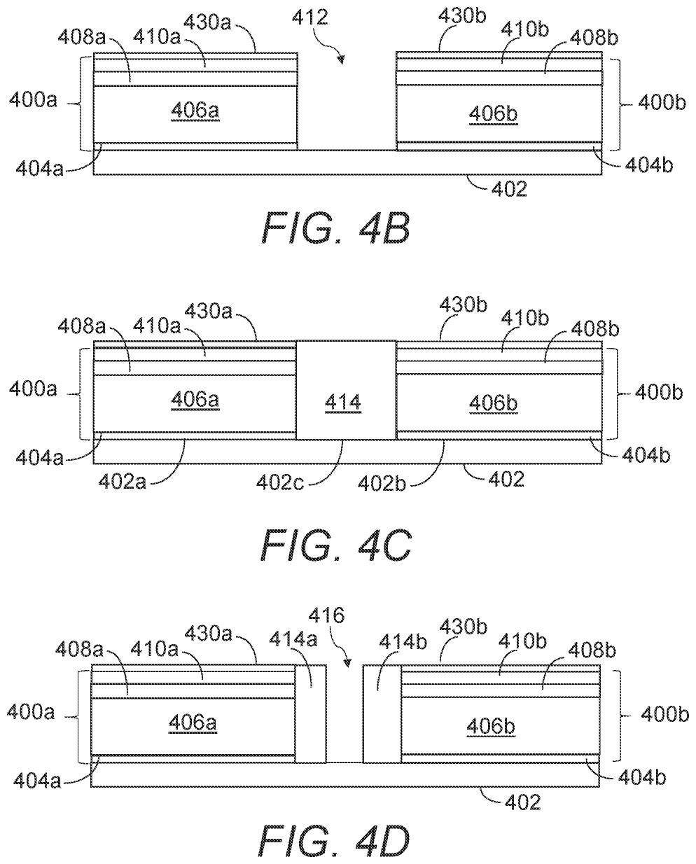

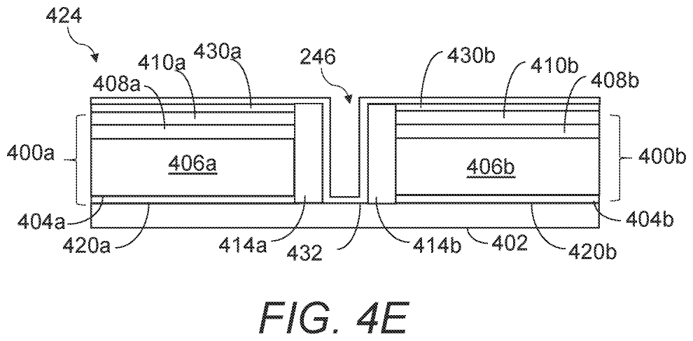

FIGS. 4a to 4e are schematic diagrams that show features of a method of manufacturing an energy storage device according to further examples. The method of FIGS. 4a to 4e is the same as the method of FIGS. 2a to 2g, except that, prior to depositing the first material within a groove between first and second stacks, a first layer of second material is deposited over the first and second stacks. Features of FIGS. 4a to 4e that are the same as corresponding features of FIGS. 2a to 2g are labelled with the same reference numeral but incremented by 200. Corresponding descriptions are to be taken to apply.

FIG. 4a illustrates a combined stack 400 prior to separation of the combined stack 400 into the first and second stacks 400a, 400b. The stack 400 of FIG. 4a is similar to the stack 100 of FIG. 1. However, a first layer 430 of the second material has been deposited over the stack 400. The first layer 430 of the second material is deposited on the second electrode layer 410 of the stack 400 in this example, and is the same as the second material 218 described with reference to FIGS. 2a to 2g. For example, the first layer 430 of the second material may comprise copper, and may be deposited in a vacuum. It is to be appreciated that by depositing the first layer 430 of the second material over the combined stack 400, as shown in FIG. 4a, the first layer 430 of the second material is deposited over the first and second stacks, as the combined stack 400 comprises the layers from which the first and second stacks are formed.

The first layer 430 of the second material in this case forms part of a CC layer (in this case, an anode CC layer). The first layer 430 protects underlying layers of the stack 400 from damage or other degradation due to exposure to an ambient environment. For example, as the second electrode layer 410 in this example comprises lithium, which is highly reactive, the first layer 430 acts as a barrier between the highly reactive second electrode layer 410 and a surrounding environment. The first layer 430 therefore reduces interactions between the second electrode layer 410 and the environment, which can improve the performance of the manufactured energy storage device and improve the safety of the manufacturing process. Interactions between the second electrode layer 410 and the environment are further reduced in this case due to the deposition of the layers of the stack 400 and the first layer 430 of the second material in a vacuum. As the second material itself is less sensitive to environmental conditions than the second electrode layer 410, the stack 400 may be exposed to a non-vacuum environment after deposition of the first layer 430 of the second material over the stack 400, e.g. for further processing, without unduly affecting the performance of the manufactured energy storage device.

In FIG. 4a, the first layer 430 of the second material is deposited over substantially all (in this case all) of the combined stack 400 (although this is merely an example). This protects underlying layers of the combined stack 400 from unwanted interactions with the environment. This also simplifies the deposition of the first layer 430 compared to deposition according to a particular pattern.

FIG. 4b shows the formation of first and second stacks 400a, 400b by providing a groove 412 through the combined stack 400 shown in FIG. 4a. FIG. 4b illustrates the same process as FIG. 2a, except that first and second portions 430a, 430b of the first layer 430 of the second material is arranged on the first and second stacks 400a, 400b (on the second electrode layers 410a, 410b). It is to be appreciated that, in other examples, the groove 412 may be formed through the combined stack 400 to create the first and second stacks 400a, 400b before subsequently depositing the first layer 430 of the second material on the first and second stacks 400a, 400b.

FIG. 4c shows the deposition of the first material 414 in the groove 412, to insulate the exposed edges of the first and second stacks 400a, 400b. In this example, the first material 414 also covers the exposed edges of the first and second portions 430a, 430b of the first layer of the second material, although this need not be the case in other examples.

FIG. 4d shows the formation of a second groove 416 through the first material 414 for subsequent deposition of a second layer of second material, for electrical connection of first and second cells formed from the first and second stacks 400a, 400b. The processes of FIGS. 4b to 4d in this example are performed under non-vacuum conditions. However, the first layer 430 of the second material protects underlying layers of the first and second stacks 400a, 400b, and reduces unwanted reactions between these layers and a non-vacuum environment.

FIG. 4e shows the deposition of the second material over the first stack 400a, the first material 414 and the second stack 400b, as a second layer 432 of the second material. FIG. 4e illustrates the same process as that described above with reference to FIG. 2d, except that the second material is deposited on the first layer 430 of the second material rather than on the second electrode layers 410a, 410b of the first and second stacks 400a, 400b. In other words, the first layer 430 of the second material is between the deposited second layer 432 of the second material and the second electrode layers 410a, 410b. By depositing the second layer 432 of the second material over the first stack 400a, the first material 414 and the second stack 400b, the second electrode layers 410a, 410b can be straightforwardly connected to a further electrical component, via the second layer 432 of the second material, with a greater contact area between the second electrode layers 410a, 410b and the second material, and between the second material and the further electrical component.

The intermediate structure 424 shown in FIG. 4e may undergo further processing, such as that shown in FIGS. 4e to 4g, in order to expose the first electrode layer (which may be referred to as cathode reveal), and singulate the stack into cells. The singulated cells may be stacked and connected together in series or parallel.

Although the example of FIGS. 4a to 4e involves single-sided processing, it is to be appreciated that the method of FIGS. 4a to 4e may equally be performed in a double-sided manner, e.g. as described with reference to FIG. 3.

The above embodiments are to be understood as illustrative examples. Further examples are envisaged.

For example, the above-described Figures illustrate first and second stacks with a first electrode layer and a CC layer between the first electrode layer and the substrate. In other examples, which are otherwise the same as the above-described examples, the CC layer may be omitted or the first electrode layer may comprise the CC layer. In examples in which the first electrode layer comprises the CC layer, forming a further groove through the first stack to expose the first electrode layer may comprise forming the further groove to expose the CC layer of the first electrode layer, within the groove. For example, the CC layer of the first electrode layer may be used to electrically connect the first electrode layer to a further electrical component such as an electrical connector.

FIGS. 2a to 2g illustrate an example in which a second groove 216 is formed through the first material 214 before the second material 218 is deposited. In other examples, though, the second material may be deposited over the first stack, the first material and the second stack without formation of a second groove.

In the examples above, the cathode is closer to the substrate than the anode. In other examples that are otherwise the same as the above-discussed examples, the anode may be closer to the substrate than the cathode. For example, the first electrode layer may be an anode layer and the second electrode layer may be a cathode layer. In such cases, the layers that act as current collector layers (if present) may also be reversed compared to the above-described examples, e.g. such that the second material functions as a cathode CC, and the CC layer between the first electrode layer and the substrate functions as an anode CC.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed within the scope of the accompanying claims.

1. A method comprising:
providing, on a substrate, a first stack for an energy storage device and a second stack for the energy storage device with a groove therebetween, the first stack and the second stack each, respectively, comprising:
a first electrode layer on the substrate;
an electrolyte layer on the first electrode layer; and
a second electrode layer on the electrolyte layer;
depositing a first material within the groove; and
depositing a second material over the first stack, the first material and the second stack to electrically connect the second electrode layer of the first stack to the second electrode layer of the second stack, via the second material,
wherein the first material prevents the second material from contacting the first electrode layer of the first and second stacks and the electrolyte layer of the first and second stacks, to electrically insulate the first electrode layer of the first and second stacks and the electrolyte layer of the first and second stacks from the second material.

2. The method according to claim 1, wherein the groove is a first groove and the method comprises forming a second groove through the first material and depositing the second material in the second groove.

3. The method according to claim 1, wherein depositing the second material comprises depositing the second material using a non-inkjet-printing method.

4. The method according to claim 1, wherein depositing the first material comprises depositing the first material in a non-vacuum environment and depositing the second material comprises depositing the second material in a vacuum.

5. The method according to claim 4, wherein the non-vacuum environment is at least one of: an inert environment or a dry-room environment.

6. The method according to claim 1, comprising:
depositing a first layer of the second material over the first stack and the second stack before depositing the first material within the groove; and
subsequently depositing the second material over the first stack, the first material and the second stack, as a second layer of the second material.

7. The method according to claim 6, wherein depositing the first layer of the second material comprises depositing the first layer of the second material in a vacuum and depositing the first material comprises depositing the first material in a non-vacuum environment.

8. The method according to claim 1, wherein the first stack is on a first portion of the substrate, the second stack is on a second portion of the substrate and depositing the second material comprises depositing a portion of the second material on a third portion of the substrate, between the first and second portions of the substrate.

9. The method according to claim 1, wherein the first stack and the second stack each, respectively, comprise a first surface on the substrate and a second surface opposite to the first surface, and depositing the second material over the first stack, the first material and the second stack comprises depositing the second material to cover substantially all of the second surface of at least one of the first or second stacks.

10. The method according to claim 1, comprising:
depositing a combined stack comprising the first stack and the second stack; and
forming the groove through the combined stack to form the first stack and the second stack with the groove therebetween.

11. The method according to claim 10, wherein a width of the groove is substantially constant through the combined stack.

12. The method according to claim 1, further comprising, after depositing the second material, separating a first portion of the substrate on which the first stack is arranged from a second portion of the substrate on which the second stack is arranged, the separating comprising cutting through the second material within the groove.

13. The method according to claim 1, further comprising, after depositing the second material, forming a further groove through the first stack to expose the first electrode layer of the first stack within the second groove.

14. The method according to claim 13, wherein forming the further groove comprises forming the further groove through the first stack and through the substrate.

15. (canceled)

16. An intermediate structure for an energy storage device, the intermediate structure comprising:
a substrate;
a first stack for the energy storage device on the substrate;
a second stack for the energy storage device on the substrate,
the first stack and the second stack each, respectively, comprising:
a first electrode layer on the substrate;
an electrolyte layer on the first electrode layer; and
a second electrode layer on the electrolyte layer;
a first material between the first stack and the second stack; and
a second material over the first stack, the first material and the second stack to electrically connect the second electrode layer of the first stack to the second electrode layer of the second stack, via the second material,
wherein the first material prevents the second material from contacting the first electrode layer of the first and second stacks and the electrolyte layer of the first and second stacks, to electrically insulate the first electrode layer of the first and second stacks and the electrolyte layer of the first and second stacks from the second material.

17. The intermediate structure according to claim 16, wherein the first stack is on a first portion of the substrate, the second stack is on a second portion of the substrate and a portion of the second material is on a third portion of the substrate, between the first portion of the substrate and the second portion of the substrate.

18. The intermediate structure according to claim 16, wherein the first stack and the second stack each, respectively, comprise a first surface on the substrate and a second surface opposite to the first surface, and the second material overlaps substantially all of the second surface of at least one of the first or second stacks.

19. The intermediate structure according to claim 16, wherein the second electrode layer comprises lithium.

20. The intermediate structure according to claim 16, wherein the second material comprises copper.
